(19) United States
(12) Patent Application Publication
(10) Pub. No.: US 2022/0095704 A1
(43) Pub. Date: Mar. 31, 2022

(54) PRODUCTION OF CUSTOM GARMENTS BY ADDITIVE MANUFACTURING

(71) Applicant: Carbon, Inc., Redwood City, CA (US)

(72) Inventors: Sarah Salemeh, San Francisco, CA (US); Eleni Alexandraki, Kifisia-Attiki (GR); Shawn Fortner, Redwood City, CA (US)

(21) Appl. No.: 17/483,028

(22) Filed: Sep. 23, 2021

Related U.S. Application Data
(60) Provisional application No. 63/085,559, filed on Sep. 30, 2020.

(51) Int. Cl. A41C 5/00; A41C 3/00; B33Y 10/00; B33Y 50/00; B33Y 80/00

(52) U.S. Cl. CPC A41C 5/005; A41C 3/0014; B33Y 80/00; B33Y 50/00; B33Y 10/00

(57) ABSTRACT

A method of making a support garment, comprising: (a) receiving, into a computing system, a 3D image of a human body portion; (b) generating in said computing system an initial virtual 3D model of a support garment in a configuration corresponding to said 3D image, said garment having an outer surface, an inner (body facing) surface, and a thickness dimension therebetween, (c) generating from said initial virtual 3D model a flattening virtual 3D model of said support garment in said computing system, the flattened virtual model in a configuration for additive manufacturing thereof with either said outer surface or said inner surface adhered to a generally planar build platform; and (d) identifying a first zone of either said initial or said flattened virtual 3D model; (e) modifying (before or after step (c), preferably after step (c)) said first zone of said virtual 3D model to comprise a perforated sheet.

### RELATED APPLICATIONS

This application claims priority to U.S. Provisional Application No. 62/475,496, filed Mar. 23, 2017, the disclosure of which is hereby incorporated by reference in its entireties.

### FIELD OF THE INVENTION

The present invention concerns methods of manufacturing custom garments, such as custom brassieres, by additive manufacturing, and the custom garments so produced.

### BACKGROUND OF THE INVENTION

Garments such as brassieres are generally manufactured to a set of standardized sizes and shapes, resulting in their being ill-fitting and uncomfortable. The need remains for methods of making such garments that are better tailored to each individual wearer.

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of the growing object through a light transmissive window, or “top down” techniques, where light is projected onto the resin on top of the growing object, which is then immersed downward into the pool of resin.

While stereolithography and other additive manufacturing techniques have largely been used to make prototypes rather than commercial products, the recent introduction of a more rapid stereolithography technique known as continuous liquid interface production (CLIP), coupled with the introduction of “dual cure” resins for additive manufacturing, has expanded the usefulness of stereolithography from prototyping to manufacturing (see, e.g., U.S. Pat. Nos. 9,211,678; 9,205,601; and U.S. Pat. No. 9,216,546 to DeSimone et al.; and also in J. Tumbleston, D. Shirvanyants, N. Ermoshkin et al., Continuous liquid interface production of 3D Objects, Science 347, 1349-1352 (2015); see also Rolland et al., U.S. Pat. Nos. 9,676,963, 9,453,142 and 9,598,606). Adaptation of such techniques to manufacturing custom garments has, however, lagged.

### SUMMARY OF THE INVENTION

According to some embodiments of the current invention, a method of making a support garment, comprises (a) receiving, into a computing system, a 3D image of a human body portion; (b) generating in the computing system an initial virtual 3D model of a support garment in a configuration corresponding to the 3D image, the garment having an outer surface, an inner (body facing) surface, and a thickness dimension therebetween, (c) generating from the initial virtual 3D model a flattening virtual 3D model of the support garment in the computing system, the flattened virtual model in a configuration for additive manufacturing thereof with either the outer surface or the inner surface adhered to a generally planar build platform; and (d) identifying a first zone of either the initial or the flattened virtual 3D model; (e) modifying (before or after step (c), preferably after step (c)) the first zone of the virtual 3D model to comprise a perforated sheet (or a lattice mesh).

In some embodiemtns, the perforated sheet has an average thickness not greater than 2, 5, or 10 millimeters. In some embodiments, the perforated sheet comprises a lattice mesh. In some embodiments, the lattice mesh consists of repeating unit cells connected in a single layer. In some embodiments, the repeating unit cells include independent interconnected links and are connected to one another at common struts.

In some embodiments, the repeating unit cells comprise independent interconnected links (e.g., in the style of chain mail).

In some embodiments, the method further includes (b) taking a quality control measure from the initial virtual 3D model along a predetermined dimension; and (c′) taking a second quality control measure from the flattened virtual 3D model along the predetermined dimension; and (c″) rejecting the flattened virtual 3D model if the second quality control measure deviates from the first quality control measure by a predetermined tolerance (e.g., by more than 1, 2, 5, or 10 percent).

In some embodiments, the generating step further comprises modifying at least a second zone of the virtual 3D model to comprise a support segment (for example, that has an average density at least 50 percent or 100 percent greater than the perforated sheet or lattice mesh).

In some embodiments, the generating step further comprises modifying at least a third zone of the virtual 3D model to include a connector segment.

In some embodiments, the generating step further comprises: (i) dividing the virtual 3D model into at least two portions, and (ii) adding corresponding connector segments to each of the at least two portions.

In some embodiments, the 3D image is from a specific person, and the generating step optionally, but preferably, includes adding a unique identifier to the virtual 3D model, the unique identifier corresponding to the person.

In some embodiments, the support garment is a compression garment, and the generating step includes modifying at least the first distinct zone to impart compression force to a wearer of the garment.

In some embodiments, the generating step (b) further comprises adding at least one additional structural feature (e.g., a pocket or channel, such as for a sensor, or for pneumatic tubing for therapeutic applications, etc.) to the garment outer surface (preferably with the inner surface adhered to the build platform during any subsequent producing step).

In some embodiments, the garment comprises a brassiere (including swimwear top), or a compression garment or compression sleeve (e.g., a sports brassiere, a back or lumbar support, an ankle support, a knee support, a wrist support, an elbow support, arm, thigh or calf compression sleeve, a compression stocking (e.g., for the treatment or prevention of ulcers, deep vein thrombosis, lymphoedema, etc.), or the like, including portions threof).

In some embodiments, the garment has at least one split therein joinable to form a seam through opposing connector segments.

In some embodiments, the garment comprises a brassiere front portion including left and right cups, a left lateral segment, a left underlying segment, a left medial segment, a center segment, a right medial segment, a right underlying segment, and a right lateral segment, and the generating step includes: (i) modifying the left and right cups to comprise the a perforated sheet (or lattice mesh); (ii) modifying the left and right lateral segments, left and right lower segments, and left and right medial segments to comprise the support structure (e.g., a denser or less elastic perforated sheet than that of the cups).

In some embodiments, the method further includes (iii) dividing the front portion through the center segment to produce half portions having opposing edge portions; and (iv) adding corresponding connector segments to the opposing edge portions.

In some embodiments, the garment is elastic.

In some embodiments, the method includes (d) producing the support garment from the flattened virtual 3D model and a light polymerizable resin on an additive manufacturing apparatus; (e) optionally, but in some embodiments, preferably cleaning the support garment or part thereof (e.g., by washing, centrifugal separation, wiping, blowing, or a combination thereof); and then (f) optionally, but in some embodiments preferably, further curing the object (e.g., by baking, when the resin is a dual cure resin).

In some embodiments, the producing step is carried out by bottom up stereolithography (e.g., CLIP), top down stereolithography, or multi jet printing.

In some embodiments, the further curing step is carried out with the object in a flattened state.

In some embodiments, the further curing step is carried out with the object on a contoured form.

In some embodiments, the light polymerizable resin comprises a resin for a polymerized product comprised polyurethane, polyurea, or copolymer thereof, or for product comprised of silicone

In some embodiments, the resin comprises a dual cure resin.

In some embodiments, a garment is produced by the method described herein.

In some embodiments, an additively manufactured brassiere, comprises left and right cups, each cup comprising a perforated sheet; a center segment connecting the left and right cups to one another; a left lateral segment, a left underlying segment, and a left medial segment all connected to the left cup; a right medial segment, a right underlying segment, and a right lateral segment all connected to the right cup; the left and right lateral segments, left and right lower segments, and left and right medial segments all comprising support structures, the cups and the support structures all produced concurrently with one another and connected to one another from the same light polymerizable resin by additive manufacturing.

In some embodiments, the brassier divided through the center segment to produce half portions having opposing edge portions each edge portion having corresponding connector segments formed thereon.

In some embodiments, the brassiere is elastic.

In some embodiments, the perforated sheet has an average thickness not greater than 2 or 5 millimeters.

In some embodiments, the perforated sheet consists of repeating unit cells connected in a single layer.

In some embodiments, the repeating unit cells are connected to one another at common struts.

In some embodiments, the repeating unit cells comprise independent interconnected links (e.g., in the style of chain mail).

In some embodiments, each of the cups having a fabric comfort liner connected thereto (i.e., in a configuration that contacts the skin of the wearer).

According to further embodiments according to the invention, a method of making a support garment and complementary prosthesis includes (a) receiving, into a computing system, a 3D image of a human body portion; (b) generating in the computing system a virtual 3D model of a custom prosthesis that conforms to the 3D image of a human body portion; (c) generating in the computing system an initial virtual 3D model of a support garment in a configuration corresponding to the 3D image and the custom prosthesis, the garment having an outer surface, an inner (body facing) surface, and a thickness dimension therebetween, and (d) modifying at least a first zone of the initial virtual 3D model to comprise a perforated sheet.

In some embodiments, generating a virtual 3D model of a custom prosthesis and an initial virtual 3D model of a support garment comprises: dividing the virtual 3D model of a custom prosthesis and the initial virtual model of a support garment into subsections; dividing the subsections into functional zones, the functional zones including the first zone; and filling selected ones of the functional zones with a perforated sheet, support structures, or connector segments.

In some embodiments, the 3D image of a human body portion comprises input data of an intact breast and a resected breast, and the virtual model of a custom prosthesis is generated based on the input data of the intact breast (e.g., a mirror image of the opposite intact breast such that a combination of the virtual model of the custom prosthesis with the 3D image of a human body portion results in the resected breast approximating a mirror image of the intact breast).

In some embodiments, the virtual model of a custom prosthesis is generated based on pre-operative image data of a resected breast, stock input data, or input data of an intact breast or combinations thereof.

In some embodiments, the virtual model of a custom prosthesis comprises a 3D image and a mass or density distribution.

In some embodiments, the method includes determining the mass or density distribution of the virtual model of a custom prosthesis based on input from a load sensor applied to a subject (e.g., with strain gauges on straps of a test or fitting garment).

In some embodiments, the virtual model of a custom prosthesis comprises an exterior surface portion and an interior portion that is at least partially hollow, wherein the virtual model of the custom prosthesis is configured for being filled with additional material.

In some embodiments, the virtual model of a custom prosthesis is configured to be encapsulated in an additional material.

In some embodiments, the method includes generating from the initial virtual 3D model a flattening virtual 3D model of the support garment in the computing system, the flattened virtual model in a configuration for additive manufacturing thereof with either the outer surface or the inner surface adhered to a generally planar build platform.

In some embodiments, the perforated sheet has an average thickness not greater than 2, 5, or 10 millimeters.

In some embodiments, the perforated sheet consists of repeating unit cells connected in a single layer.

In some embodiments, the repeating unit cells are connected to one another at common struts.

In some embodiments, the repeating unit cells comprise independent interconnected links (e.g., in the style of chain mail).

In some embodiments, the method includes (b) taking a quality control measure from the initial virtual 3D model of a support garment and the virtual 3D model of a custom prosthesis along a predetermined dimension; and (c′) taking a second quality control measure from the flattened virtual 3D model along the predetermined dimension; and (c″) rejecting the flattened virtual 3D model if the second quality control measure deviates from the first quality control measure by a predetermined tolerance (e.g., by more than 1, 2, 5, or 10 percent).

In some embodiments, the generating step further comprises modifying at least a second zone of the virtual 3D model to comprise a support segment (for example, that has an average density at least 50 percent or 100 percent greater than the perforated sheet).

In some embodiments, the generating step further comprises modifying at least a third zone of the virtual 3D model to include a connector segment.

In some embodiments, the generating step further includes (i) dividing the virtual 3D model into at least two portions, and (ii) adding corresponding connector segments to each of the at least two portions.

In some embodiments, the 3D image is from a specific person, and the generating step optionally, but preferably, includes adding a unique identifier to the virtual 3D model, the unique identifier corresponding to the person.

In some embodiments, the support garment is a compression garment, and the generating step includes modifying at least the first distinct zone to impart compression force to a wearer of the garment.

In some embodiments, the generating step (b) further comprises adding at least one additional structural feature (e.g., a pocket or channel, such as for a sensor, or for pneumatic tubing for therapeutic applications, etc.) to the garment outer surface (preferably with the inner surface adhered to the build platform during any subsequent producing step).

In some embodiments, the garment comprises a sleeve or compression sleeve for a limb, and the prosthesis comprises a limb.

In some embodiments, the garment has at least one split therein joinable to form a seam through opposing connector segments.

In some embodiments, the garment comprises a brassiere front portion including left and right cups, a left lateral segment, a left underlying segment, a left medial segment, a center segment, a right medial segment, a right underlying segment, and a right lateral segment, and the generating step includes: (i) modifying the left and right cups to comprise a perforated sheet; (ii) modifying the left and right lateral segments, left and right lower segments, and left and right medial segments to comprise the support structure (e.g., a denser or less elastic mesh than that of the cups).

In some embodiments, the method comprises (iii) dividing the front portion through the center segment to produce half portions having opposing edge portions; and (iv) adding corresponding connector segments to the opposing edge portions.

In some embodiments, the garment is elastic.

In some embodiments, the method includes (d) producing the support garment from the flattened virtual 3D model and a light polymerizable resin on an additive manufacturing apparatus; (e) optionally, but in some embodiments, preferably cleaning the support garment or part thereof (e.g., by washing, centrifugal separation, wiping, blowing, or a combination thereof); and then (f) optionally, but in some embodiments preferably, further curing the object (e.g., by baking, when the resin is a dual cure resin).

In some embodiments, the producing step is carried out by bottom up stereolithography (e.g., CLIP), top down stereolithography, or multi jet printing.

In some embodiments, the further curing step is carried out with the object in a flattened state.

In some embodiments, the further curing step is carried out with the object on a contoured form.

In some embodiments, the light polymerizable resin comprises a resin for a polymerized product comprised polyurethane, polyurea, or copolymer thereof, or for product comprised of silicone

In some embodiments, the resin comprises a dual cure resin.

In some embodiments, a kit comprising a garment and custom prosthesis produced by the methods described herein.

In some embodiments, a kit includes an additively manufactured brassiere, comprising: left and right cups, each cup comprising a perforated sheet; a center segment connecting the left and right cups to one another; a left lateral segment, a left underlying segment, and a left medial segment all connected to the left cup; a right medial segment, a right underlying segment, and a right lateral segment all connected to the right cup; the left and right lateral segments, left and right lower segments, and left and right medial segments all comprising support structures, the cups and the support structures all produced concurrently with one another and connected to one another from the same light polymerizable resin by additive manufacturing; and a custom prosthesis, comprising: an additively manufactured 3D body that conforms to a portion of at least one of the left or right cups.

In some embodiments, the brassier is divided through the center segment to produce half portions having opposing edge portions each edge portion having corresponding connector segments formed thereon.

In some embodiments, the brassiere is elastic.

In some embodiments, the perforated sheet has an average thickness not greater than 2 or 5 millimeters.

In some embodiments, the perforated sheet consists of repeating unit cells connected in a single layer.

In some embodiments, the repeating unit cells are connected to one another at common struts.

In some embodiments, the repeating unit cells comprise independent interconnected links (e.g., in the style of chain mail).

In some embodiments, each of the cups having a fabric comfort liner connected thereto (i.e., in a configuration that contacts the skin of the wearer).

In some embodiments, the additively manufactured 3D body of the custom prosthesis comprises a hollow interior portion that is configured to be filled with a material.

In some embodiments, the additively manufactured 3D body of the custom prosthesis comprises a perforated sheet.

The foregoing and other objects and aspects of the present invention are explained in greater detail in the drawings herein and the specification set forth below. The disclosures of all United States patent references cited herein are to be incorporated herein by reference. While the invention is described herein primarily with reference to brassieres, it will be appreciated that other support garments, particularly compression garments for sports and medical purposes, can also be produced by the techniques described herein.

### BRIEF DESCRIPTION OF THE DRAWINGS

FIG. 1 illustrates a custom brassiere front portion, further divided and produced in two half portions (inner comfort lining not shown).

FIG. 2 illustrates one half portion of the custom brassiere front portion of FIG. 1.

FIG. 3 illustrates a complete brassiere incorporating the front portion of FIG. 1, and a back portion produced as two halves, all with corresponding connector segments.

FIG. 4 is a photograph of a custom brassiere front segment, produced in two halves, showing in detail the the two halves joined by corresponding connector segments.

FIGS. 5A-5C are photographs of additively manufactured, single layer, perforated sheets comprising lattice meshes (i.e., lattice sheets) of different thicknesses that may be incorporated into custom garments as described herein.

FIG. 6A is a schematic overview of a process as described herein.

FIG. 6B is a more detailed schematic overview of a portion of the process of FIG. 5A.

FIG. 6C is a more detailed schematic overview of a portion of the process of FIG. 5B, introducing quality control (QC) features for the flattening step.

FIGS. 7-8 schematically illustrate the initial steps of generating a virtual model of a custom brassiere from an imported image of the torso of the garment's intended recipient.

FIGS. 9A-9B schematically illustrate dividing the garment of FIGS. 7-8 into front and back portions.

FIGS. 10A-E schematically illustrate the steps of (FIG. 10A) from a divided garment of FIGS. 9A-9B, (FIG. 10B) flattening the garment for additive manufacturing, (FIG. 10C) adding connector segments, (FIG. 10D) reinforcing supporting and connecting segments, and (FIG. 10E) additiely manufacturing the completed garment.

FIG. 11A is a schematic overview of a process of FIGS. 5A-5C, further including breast prosthesis features.

FIG. 11B is a more detailed schematic overview of a portion of the process of FIG. 11A.

FIGS. 12A-12I are images of additively manufactured, single layer, perforated sheets of different perforation patterns that may be incorporated into custom garments as described herein.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity. Where used, broken lines illustrate optional features or operations unless specified otherwise.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

“Support garment” as used herein includes complete garments, as well as partial garments such as sleeves, brassiere front portions (minus back strap and/or shoulder straps), partial stockings or leggings, etc.

1. Resins and Additive Manufacturing Steps.

Resins. Any additive manufacturing resin that results in an elastic product may be used to carry out the present invention. In some embodiments, dual cure resins are preferred, as they produce an intermediate object that is more rigid—and hence more suitable for additive manufacturing—than the final, more elastic, product. Such resins are known and described in, for example, U.S. Pat. Nos. 9,676,963, 9,453,142 and 9,598,606 to Rolland et al. Particular examples of suitable dual cure resins include, but are not limited to, elastomeric polyurethane and elastomeric silicone dual cure resins, examples of which are available from Carbon, Inc., 1089 Mills Way, Redwood City, Calif. 94063 USA.

Other Examples of suitable resins include but are not limited to those described in US Patent Application Publication No. US2020/0216692 to Studart et al.

Additive manufacturing. Techniques for producing an intermediate object, from such resins by additive manufacturing are known. Suitable techniques include bottom-up and top-down additive manufacturing, generally known as stereolithography. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the additive manufacturing step is carried out by one of the family of methods sometimes referred to as as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of CLIP include, but are not limited to: Batchelder et al., US Patent Application Pub. No. US 2017/0129169 (May 11, 2017); Sun and Lichkus, US Patent Application Pub. No. US 2016/0288376 (Oct. 6, 2016); Willis et al., US Patent Application Pub. No. US 2015/0360419 (Dec. 17, 2015); Lin et al., US Patent Application Pub. No. US 2015/0331402 (Nov. 19, 2015); D. Castanon, uS Patent Application Pub. No. US 2017/0129167 (May 11, 2017). B. Feller, US Pat App. Pub. No. US 2018/0243976 (published Aug. 30, 2018); M. Panzer and J. Tumbleston, US Pat App Pub. No. US 2018/0126630 (published May 10, 2018); K. Willis and B. Adzima, US Pat App Pub. No. US 2018/0290374 (Oct. 11, 2018) L Robeson et al., PCT Patent Pub. No. WO 2015/164234 (see also U.S. Pat. Nos. 10,259,171 and 10,434,706); and C. Mirkin et al., PCT Patent Pub. No. WO 2017/210298 (see also US Pat. App. US 201910160733).

While stereolithography techniques such as CLIP are currently preferred, it will be appreciated that other additive manufacturing techniques, such as jet printing (see, e.g., U.S. Pat. No. 6,259,962 to Gothait and US Patent App. Serial No. US 2020/0156308 to Ramos et al.) can also be used).

Once the object has been formed and optionally cleaned (e.g., by wiping, blowing, spinning, washing, etc.), the object (when produced from a dual cure resin) can then be further cured, such as by heating. Heating may be active heating (e.g., baking in an oven, such as an electric, gas, solar oven or microwave oven, or combination thereof), or passive heating (e.g., at ambient (room) temperature). Active heating will generally be more rapid than passive heating and is typically preferred, but passive heating—such as simply maintaining the intermediate at ambient temperature for a sufficient time to effect further cure—may in some embodiments also be employed. For example, when made with Carbon Inc. elastic polyurethane resin, the objects may be cleaned by centrifugal separation at 400 revolutions per minute for 3 minutes, then baked laying flat on silicone parchment in accordance with standard techniques.

2. Custom Garments and Additive Manufacturing of Same.

Any of a variety of garments can be produced by the methods described herein, including but not limited to brassieres (including swimwear tops), compression garments, and compression sleeves. Specific examples include but are not limited to sports brassieres, back or lumbar supports, ankle supports, knee supports, wrist supports, elbow supports, arm, thigh or calf compression sleeves, compression stockings (e.g., for the treatment or prevention of ulcers, deep vein thrombosis, lymphoedema, etc.), or the like, including portions threof.

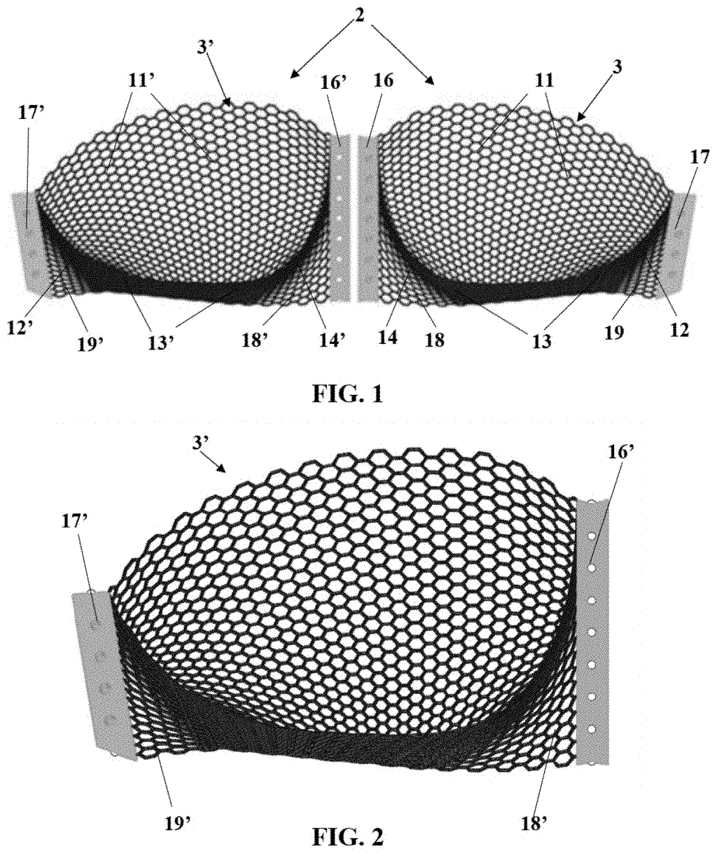

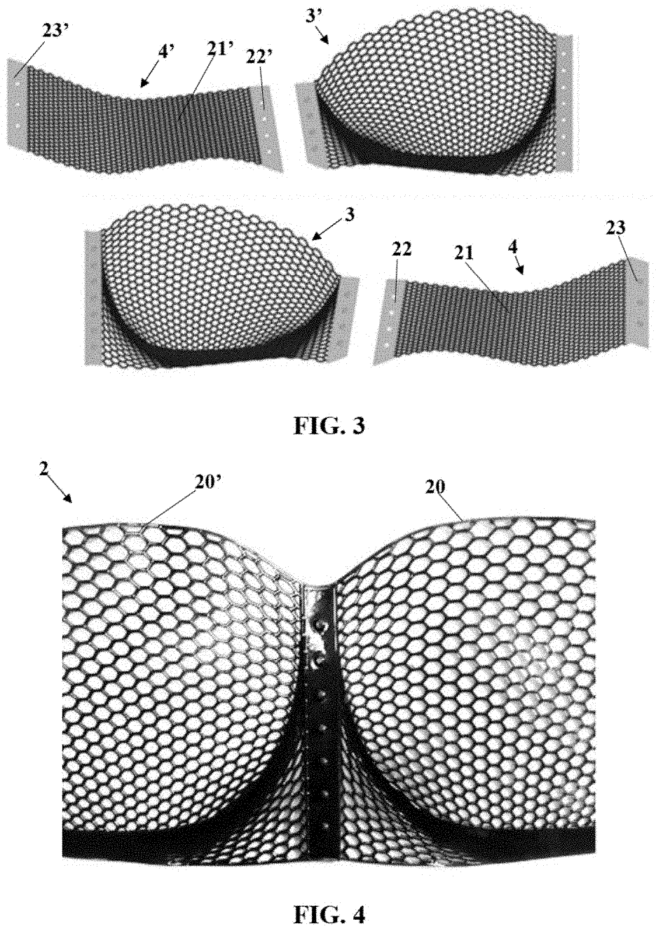

Illustrative example—additively manufactured brassiere. In one example, the garment can be an additively manufactured brassiere (2), such as illustrated in FIGS. 1-4. The illustrative garment (optionally divided into left and right segments 3, 3′) to permit additive manufacturing on smaller build platforms. The garment includes left and right cups (11, 11′), each cup comprising a perforated sheet (e.g., a lattice mesh), a center segment (split in the illustrative embodiment, but optionally continuous) connecting the left and right cups to one another.

A left lateral segment (12), a left underlying segment (13), and a left medial segment (14) are connected to the left cup around a peripheral edge portion thereof; and likewise a right medial segment (14′), a right underlying segment (13′), and a right lateral segment (12′) are all connected to the right cup around the peripheral edge portion thereof. In both cases, the lateral segment, underlying segment, and medial segments configured as support structures, having a density or stiffness greater than that of the associated cup, and are optionally but preferably continuously connected to one another to form a uniform support structure, obviating the need for a conventional underwire in the brassiere.

The cups and support structures are all produced concurrently with one another and connected to one another from the same light polymerizable resin by additive manufacturing, as discussed further below. Preferably, the brassiere is comprised of an elastic polymer, though the degree of elasticity will be less in the support structures due to the increased density (i.e., decreased pore size, increased strut thickness, increased strut width, increased overall thickness when supports are not a mesh, or combinations thereof).

As illustrated, the brassiere is divided through the center segment to produce half portions having opposing edge portions each edge portion having corresponding connector segments (16, 16′) formed thereon. Connector segments can be tabs for sewing, stapling, or other fastening, or can be connecting features such as post and orifice, hook and loop, tongue and groove, interlocking dovetails, polymer zippers (see, for example, U.S. Pat. No. 2,613,421 to Madsen), etc.

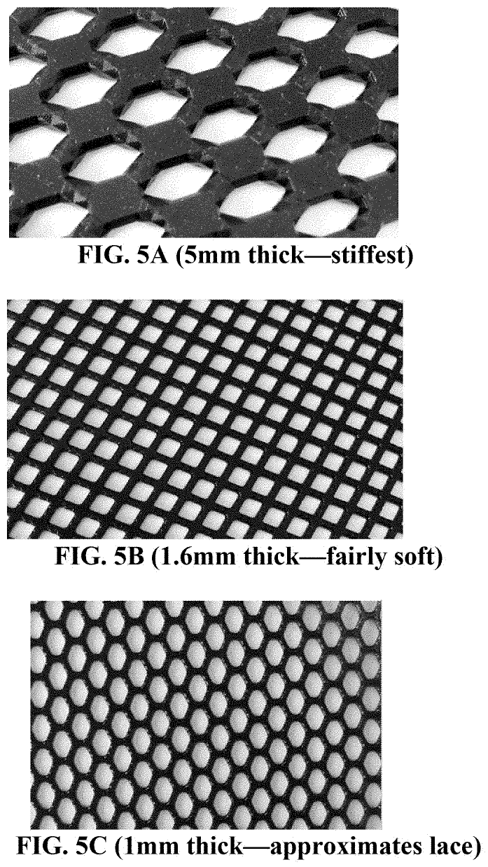

In general, the perforated sheet or lattice mesh for the cups has an average thickness not greater than 2, 3, 4 or 5 millimeters, depending on the preferences of the wearer and intended use. The mesh preferably consists of repeating unit cells connected in a single layer. The perforated sheet can include lattice mesh cells that can be connected to one another by common shared struts, as is the case with the illustrative lattices of FIGS. 5A-5C (produced from elastic polyurethane dual cure resin available from Carbon, Inc.), or in some embodiments can comprise independent (physically separate) interconnected links (e.g., in the style of chain mail). For example, the interconnected links may include independent and physically separate rings or other suitable shapes, such a woven or knit structure, that are interconnected and linked in the style of chain mail.

The illustrated brassiere has a separately produced back strap, produced in two halves (4, 4′), though the back strap can be produced as a single piece. And the backstrap need not be a more standardized part and need not even be produced by additive manufacturing. In the illustrated embodiment the back strap halves comprise a perforated sheet or lattice mesh (4, 4′), like that of the cups, though the perforated sheet need not be identical to the cups, with connector segments for connecting the backstraps to one another ((23, 23′), and with connector segments (22, 22′) for connecting the backstrap to corresponding connector segments (17, 17′) on the brassiere front.

Note also that each front half segment has a perforated sheet or lattice mesh (19, 19′) interconnecting the lateral support segment (12, 12′) with the adjacent backstrap connector segment (17, 17′), and a similar perforated sheet or lattice mesh (18, 18′) interconnecting the medial support segment (14, 14′) to the central connector segments (16, 16′). These are to enhance the overall moisture permeability (or “breathability”) of the garment. If the central segment did not include central connector segments, a continuous mesh segment could interconnect the medial support segments (14, 14′).

While shoulder straps are not shown, they can optionally be included, as similar additively manufactured, custom, items, originally connected to or separate from the other portions of the garment. The shoulder straps may in some embodiments incorporate a constant force expansion lattice, such as described in US Patent Application No. US 2019/0039213 to Merlo and McCluskey.

In some embodiments, the cups (and optionally the entire brassiere front portion) has a fabric comfort liner connected thereto, preferably in a configuration that contacts the skin of the wearer. The comfort liner can be connected to the brassiere cups (directly, or by other portions of the brassiere) by any suitable technique, such as by stitching, with adhesive, with removable fasteners such as snaps, clips, hook-and-loop fasteners, or the like. Fabric comfort liners can be made from any suitable material, including natural fibers (e.g., silk, cotton), synthetic fibers (e.g., polyester and polypropylene), and blends thereof, formed as either woven or nonwoven fabrics.

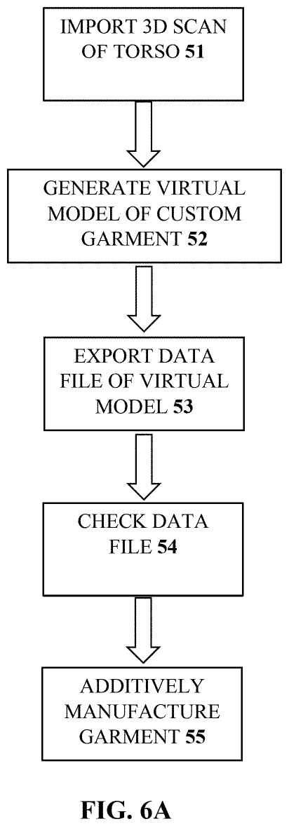

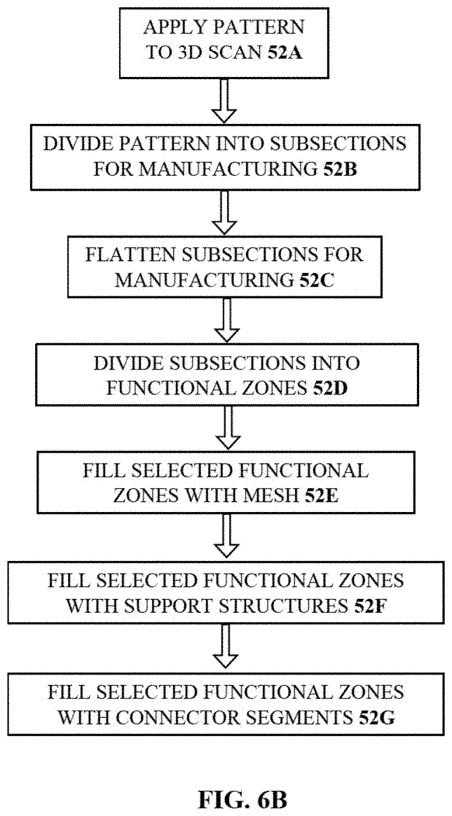

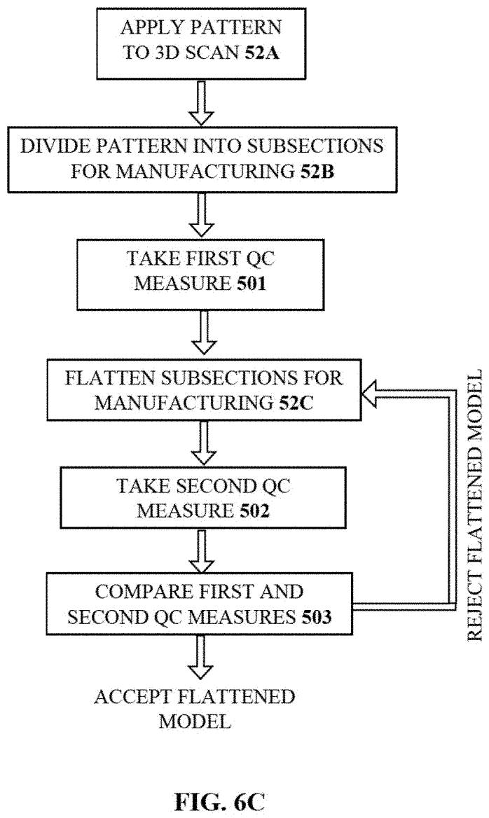

Custom design and manufacturing. Examples of methods of making a garment are given in FIGS. 6-10 herein. The methods may be carried out on any suitable computer, such as a personal computer, cloud-based computing system, or combinations thereof.

3D image. The methods generally begin by receiving or importing (for example, step 52 in FIG. 6A) into the computer system a 3D image of a human body portion (e.g., a torso, leg, arm, foot, hand, neck, or subsegment thereof) from the individual for whom the custom garment is being made (for example, (I) in FIGS. 7-10). The 3D image may be generated and provided for importation in accordance with known techniques such as those described in U.S. Pat. No. 7,043,329 to Dias et al., and US Patent Application Publication Nos. US2017/0281367 to Ketchum and Rothenberg, and US2017/0127732 to Trangmar and Marsden, or variations thereof that will be apparent to those skilled in the art. Suitable scanners are commercially available from sources such as Artec3D (2880 Lakeside Drive, No. 135, Santa Clara, Calif. 95054 USA), Mantis Vision 3iosk (94 Shlomo Shmeltzer Road, Kiryat Arie, Petrach Tivka, Israel, 4970602), and by loading software such as Trnio or scann3d into a compatible smart phone.

Generating a virtual model. Next, a virtual model of the custom garment is generated (52) in the computing system, further details of which are discussed below. Once generated a data file of the virtual model is exported (53), and optionally checked (54), manually or by an automated program, for file integrity, in accordance with known techniques. Data files for the additive manufacturing of the garment may be in any suitable file format, including but not limited to STL files, OBJ files, PLY files, 3MF file, AMF file, etc. From the data file, the garment may be manufactured (55) from a material and by a method as described above, such as from a polymerizable resin that produces an elastic product (though the degree of elasticity will vary in different regions of the garment).

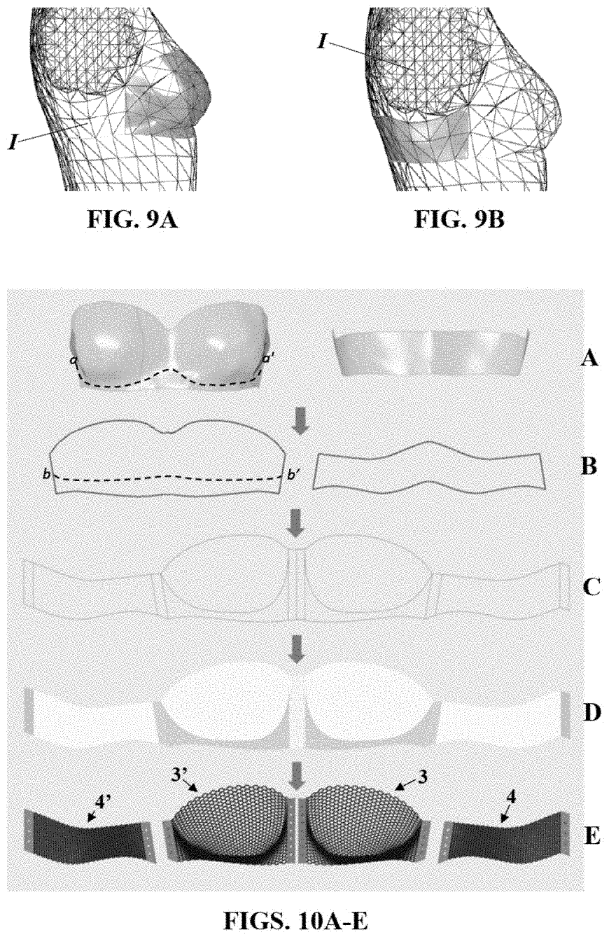

Details of a non-limiting example of the generating step (52) are given in FIG. 6B. Sequences of steps while arranged in one particular order are not critical unless indicated as such. In these embodiments, an initial pattern of the garment is applied to the 3D scan (52A). The pattern can be selected from a menu of patterns (as, in like manner, can the mesh lattices, connector segments, support segments, etc., be selected from a menu of options). The pattern can, optionally, be divided into subsections (52B) for manufacturing, for example where the build platform of an additive manufacturing apparatus may not conveniently carry the undivided model (see, for example, FIG. 9A-9B, where a brassiere pattern is divided into a front and back half). The pattern, or pattern subsections, are flattened (52C), so that the inner surface or the outer surface of the garment can be adhered to the build platform of an additive manufacturing apparatus during manufacturing: This can increase manufacturing efficiency by presenting the shortest dimension for in the “Z” direction (pull direction or vertical direction) for the additive manufacturing step. Flattening can be by any suitable technique that substantially preserves the overall surface area of the garment.

The pattern can be divided into functional zones (52D) to be filled with particular structures, the dividing step being carried out before or after the flattening step. Similarly the filling step can be carried out before or after the flattening step, though in some embodiments it is computationally more efficient to carry out filling steps after the flattening step. In general, a first functional zone is filled with a lattice mesh (52E) such as described above. In some embodiments, a second functional zone is filled with support structures (52F). In some embodiments, a third functional zone (52G) is filled with connector segments as described above. Multiple ones of the first, second, and third functional zones may be so filled.

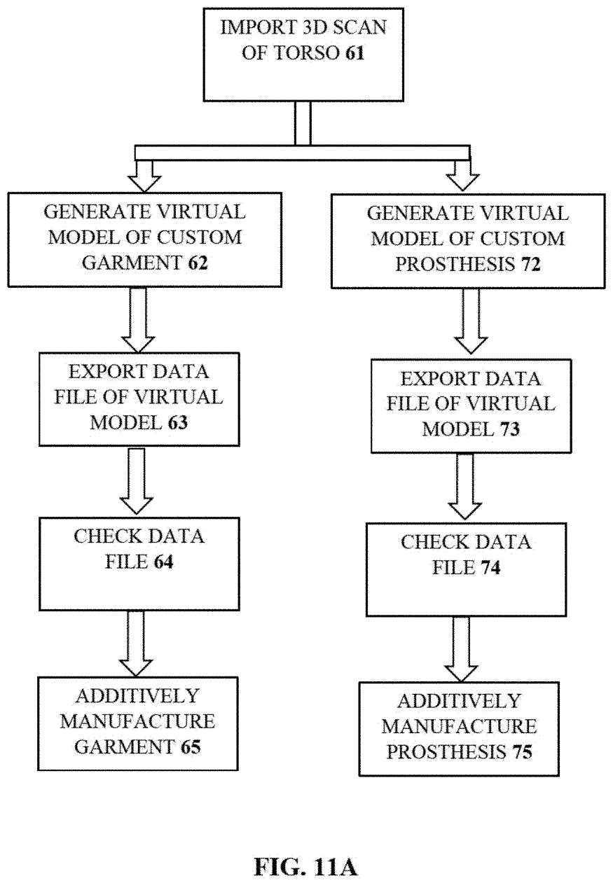

In some embodiments it is useful to introduce a quality control (QC) routine for the flattening step, such as illustrated in FIG. 6C. Steps common to those of FIG. 6B are assigned like numbers. The QC routine includes taking a first QC measure (501) from the model, prior to the flattening step, and a second QC measure (502) from the model after the flattening step. For example, the first QC measure can be a lengthwise measure of a brassiere pattern along the line a-a′ of FIG. 10A, and the second QC measure can be a corresponding lengthwise measure of the brassiere pattern along the line b-b′ of FIG. 10B. The first and second QC measure are then compared (503) and, as long as no significant deviation between the two measures is found (e.g., no deviation greater than 1, 2, 5 or 10 percent), the generating step (52) can continue with the flattened model.

When the support garment is a compression garment such as a sports bra or therapeutic sleeve, the generating step can includes modifying at least a first distinct zone to impart compression force to the wearer of the garment, from whom the 3D scan was taken. Also, the generating step can further include adding at least one additional structural feature (e.g., a pocket or channel, such as for a sensor, or for pneumatic tubing for therapeutic applications, etc.) in or on the garment, such as on on the garment outer surface (preferably with the inner surface adhered to the build platform during subsequent producing steps).

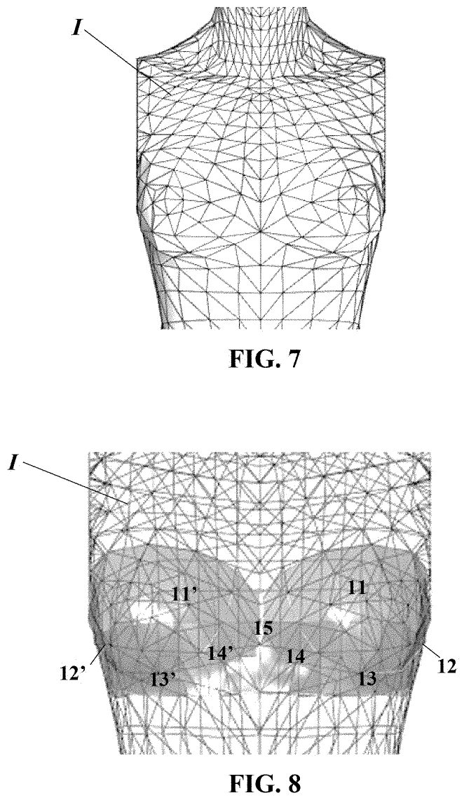

The sequence of steps is schematically illustrated with respect to generating a custom brassiere in FIGS. 7-10, where a 3D image (I) of an individual's torso is received (FIG. 7), a pattern applied to that model (FIG. 8, with zones marked with the structures to be received, though zones need not be identified at this point in the method), the pattern initially subdivided (FIGS. 9A-9B), and the virtual model for a brassiere such as as in FIGS. 1-4 generated in the sequences of FIGS. 10A-10E).

In some embodiments, the generating step optionally, but preferably, includes adding a unique identifier to the virtual 3D model, in turn printed onto the actual garment, the unique identifier corresponding to the person from whom the 3D scan was taken. The unique identifier can be in any form, such as a bar code, an alphanumeric identifier (giving an actual name, or a code), or the like.

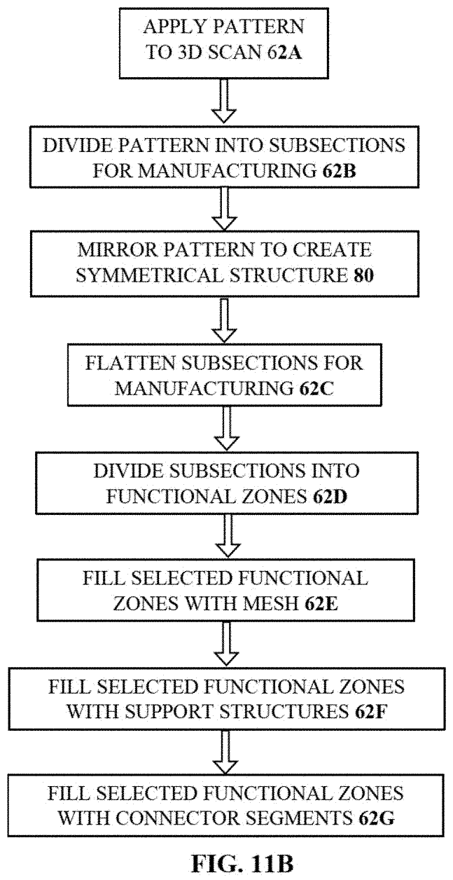

Combination of custom garment and custom prosthesis. FIGS. 11A-11B show how processes such as described above may be applied to generating a custom prosthesis, particularly a custom breast prosthesis. In FIG. 11A, steps 61, 62, 63, 64, and 65, may be carried out in like manner as steps 51, 52, 53, 54, and 55, respectively, described in connection with FIGS. 6A-6C above. In addition, the 3D image is used to generate a virtual model of a custom prosthesis, such as a breast prosthesis for a breast to be, or that has been, resected (depending on whether the scan is taken pre-operatively, or post-operatively), as shown in Steps 72-75.)

Where then scan is taken post-operatively, the shape of the breast prosthesis virtual model can be generated as a mirror image (80) of the opposite breast. In other cases, the data tile for the external breast prosthesis can be generated based on pre-operative image data of the resected breast. In still other cases the data file for the external breast prosthesis can be generated from stock input data, or combinations of any of the foregoing data sources. For example, a data file for the external breast prosthesis, independent of the brasserie, can be produced by techniques such as described in US Patent Application Pub. Nos. US2017/0281367 to Ketchum and Rothenberg, US2019/0125549 to Park et al., PCI′ Application WO2019/164390 to Munoz Arellano, or variations thereof that will be apparent to those skilled in the art. The data file can be exported (73), optionally checked for file integrity (74) and the prosthesis additively manufactured therefrom (75) in accordance with known techniques, including but not limited to those described above.

The additively manufactured external breast prosthesis can be further modified for use, such as encapsulated in additional material, filled with additional material to achieve a desired mass or weight distribution, and combinations thereof.

For example, the desired mass of the breast prosthesis can be determined from a load sensor applied to the subject, such as with strain gauges on shoulder straps of a test or fitting garment, and the prosthesis modified, by additive manufacturing and/or filling, to achieve a mass, as well as a shape, optimized for comfort and appearance for the recipient.

Finally, while not shown in FIGS. 11A-B, the steps of generating the virtual model of the custom garment (62) and generating the virtual model of the custom prosthesis (72) may also include generating, on each, corresponding alignment indicia (for example, one or more “hash marks” lines, or sets of lines indicating a matching alignment) and/or generating corresponding connecting segments (e.g., to aid in fixing or removably coupling the prosthesis to the garment).

Although some embodiments are described herein with respect to perforated sheets including mesh unit cells that are connected, for example, by common shared struts (e.g., the lattices of FIGS. 5A-5C), it should be understood that any suitable pattern of perforated sheet may be used. Examples of perforated sheets configurations and patterns may be found, for example, in “3D printing of textile-based structures by Fused Deposition Modelling (FDM) with different polymer materials,” Melnikova, et al. Global Conference on Polymer and Composite Materials (PCM 2014).

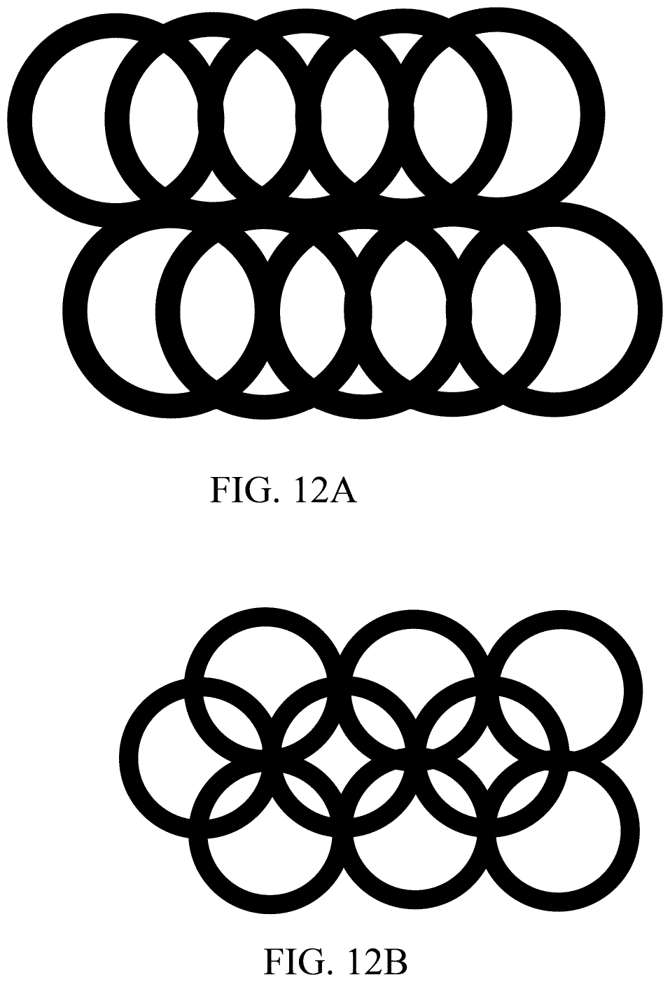

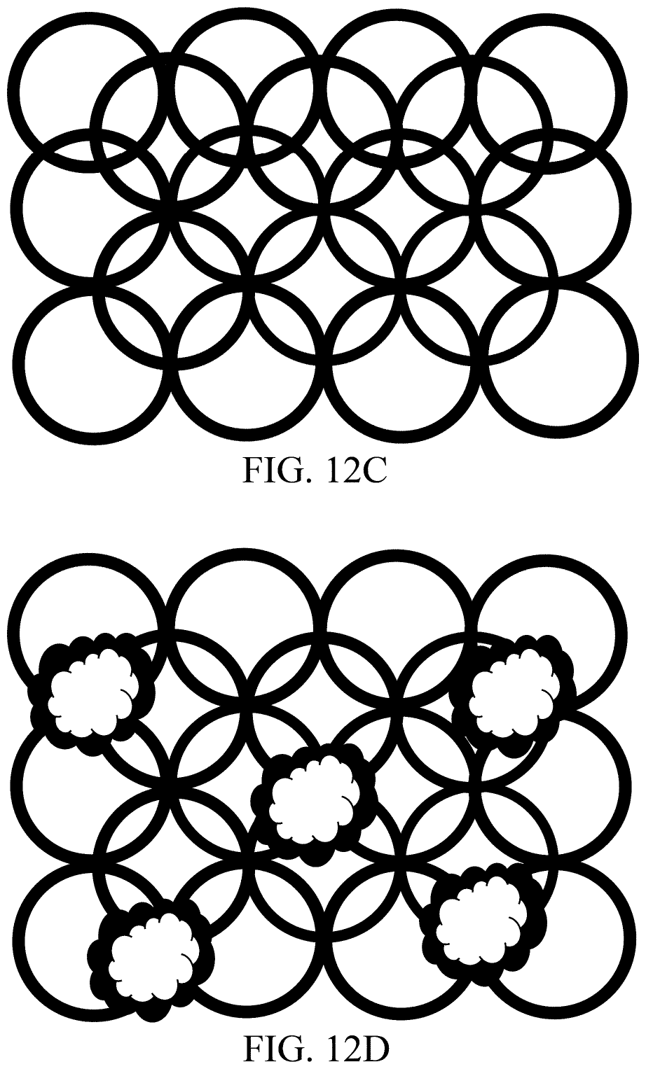

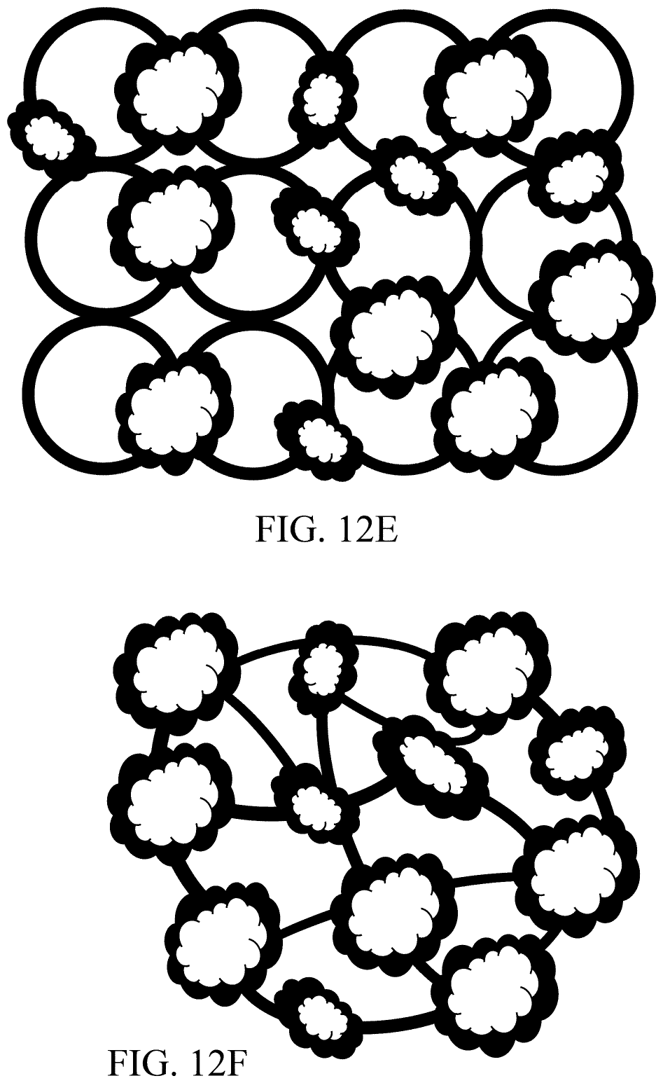

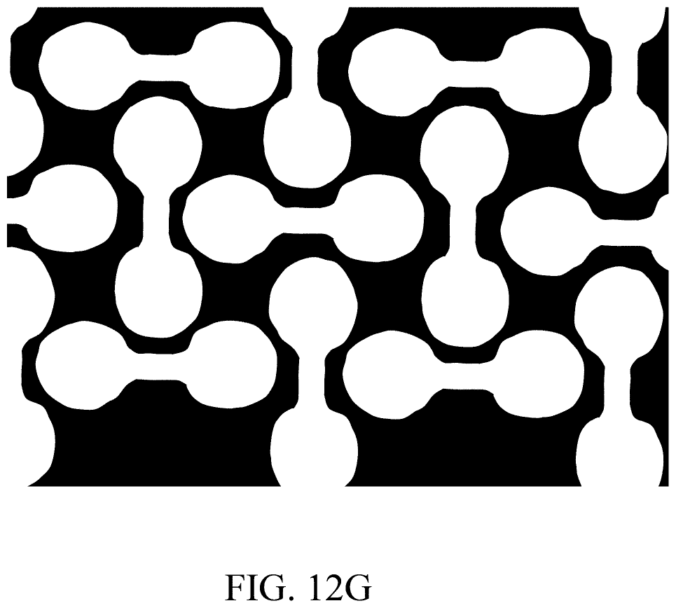

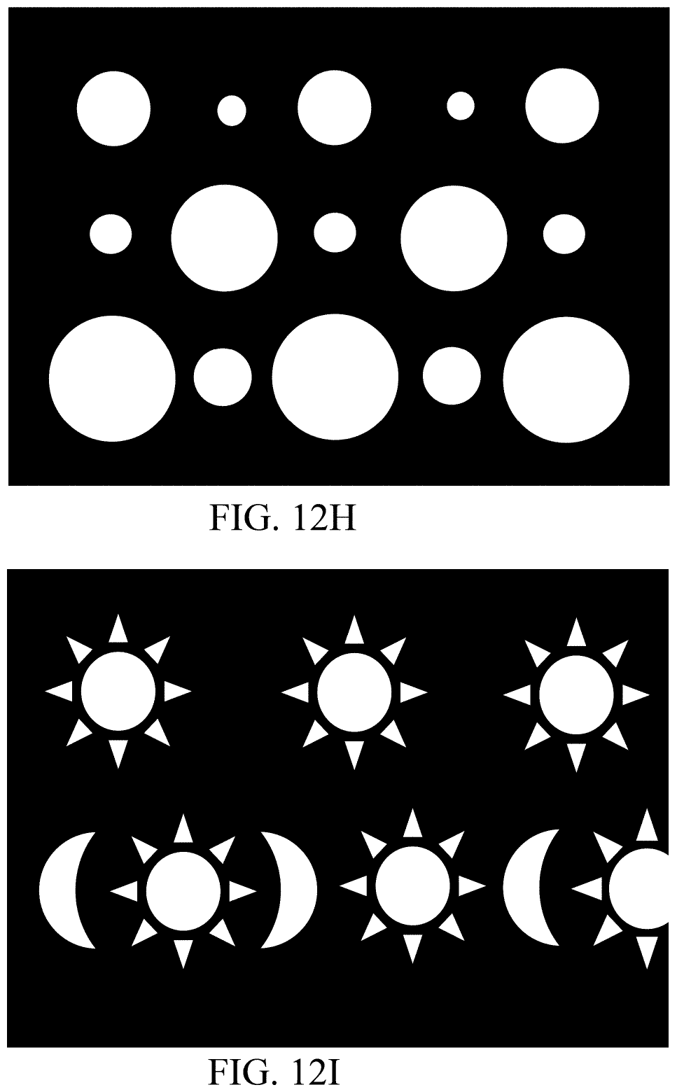

For example, FIGS. 12A-12I illustrate various example patterns of perforated sheets (produced from elastic polyurethane dual cure resin available from Carbon, Inc., shown in black with perforations in white).

As illustrated in FIGS. 12A-12I, the perforated sheets may have regular (repeating) or irregular (non-repeating) perforation patterns. The perforation patterns may include various shapes that connect via overlapping patterns, such as the overlapping rings in FIGS. 12A-12E. A single perforation shape may be repeated throughout the perforated sheet, such as shown in FIG. 12G, or irregular patterns may be used, such as shown in FIGS. 12H-12I.

The perforated sheet manufactured as described herein may have a higher proportion of perforation or void regions than sheet or resin-filled regions, such as shown with the pattern (cloud shapes connected by lines) in FIG. 12F. However, in some embodiments, the perforated sheet may have a higher proporation of sheet/resin material than void regions, such as is shown in FIGS. 12H-12I. Incresaing the void space of the perforated sheet (e.g., such as the pattern shown in FIG. 12F with a high proporation of void regions) results in a perforated sheet that is generally less dense or stiff that a perforated sheet of the same average thickness but with a higher proporation of filled resin regions (e.g., such as the patterns shown in FIGS. 12H-12I). Thus, the density and stiffness of the sheet may be related to the thickness of the resin or sheet material, and the perforation pattern. Moreover, the thickness of the sheet material may vary over the lateral dimension of the sheet.

In some embodiments, the perforated sheet is “lace-like.” That is, the perforated sheets according to some embodiments may approximate the look and feel of a fine, flexible, open fabric lace. In some embodiments, a “lace-like” perforated sheet may include looping, twisting, or knitting patterns commonly found in lace fabrics and formed with a variable resin thickness. For example, a feature or resin shape in the perforated sheet may have an increasing/decreasing thickness pattern or form various ridges or curves. In some embodiments, the variable thicknesses may be a surface texture on the outer facing surface of the sheet, and the inner or body facing surface may be smooth, or the surface texture may be on both sides of the perforated sheet. In some embodiments, the variable thickness of the sheet may mimic the thickness patterns in a lace fabric.

The foregoing is illustrative of the present invention, and is not to be construed as limiting thereof.

1. A method of making a support garment, comprising:
(a) receiving, into a computing system, a 3D image of a human body portion;
(b) generating in said computing system an initial virtual 3D model of a support garment in a configuration corresponding to said 3D image, said garment having an outer surface, an inner surface, and a thickness dimension therebetween,
(c) generating from said initial virtual 3D model a flattening virtual 3D model of said support garment in said computing system, the flattened virtual model in a configuration for additive manufacturing thereof with either said outer surface or said inner surface adhered to a generally planar build platform; and
(d) identifying a first zone of either said initial or said flattened virtual 3D model;
(e) modifying, before or after step (c), said first zone of said virtual 3D model to comprise a perforated sheet.

2. The method of claim 1, wherein said perforated sheet has an average thickness not greater than 2, 5, or 10 millimeters.

3. The method of claim 1, wherein said perforated sheet comprises a lattice mesh.

4. The method of claim 3, wherein said lattice mesh consists of repeating unit cells connected in a single layer.

5. The method of claim 4, wherein said repeating unit cells comprise independent interconnected links, are connected to one another at common struts, or a combination thereof.

6. The method of claim 1, further comprising the steps of:
(b) taking a quality control measure from said initial virtual 3D model along a predetermined dimension; and
(c′) taking a second quality control measure from said flattened virtual 3D model along said predetermined dimension; and
(c″) rejecting said flattened virtual 3D model if said second quality control measure deviates from said first quality control measure by a predetermined tolerance.

7. The method of claim 1, wherein said generating step further comprises modifying at least a second zone of said virtual 3D model to comprise a support segment having an average density greater than said perforated sheet.

8. The method of claim 1, wherein said generating step further comprises modifying at least a third zone of said virtual 3D model to include a connector segment.

9. The method of claim 1, wherein said generating step further comprises:
(i) dividing said virtual 3D model into at least two portions, and
(ii) adding corresponding connector segments to each of said at least two portions.

10. The method of claim 1, wherein said 3D image is from a specific person, and said generating step optionally includes adding a unique identifier to said virtual 3D model, said unique identifier corresponding to said person.

11. The method of claim 1, wherein said support garment is a compression garment, and said generating step includes modifying at least said first distinct zone to impart compression force to a wearer of said garment.

12. The method of claim 1, wherein said generating step (b) further comprises adding at least one additional structural feature to said garment outer surface.

13. The method of claim 1, wherein said garment comprises a brassiere, or a compression garment or compression sleeve.

14. The method of claim 13, wherein said garment has at least one split therein joinable to form a seam through opposing connector segments.

15. The method of claim 1, wherein
said garment comprises a brassiere front portion including left and right cups, a left lateral segment, a left underlying segment, a left medial segment, a center segment, a right medial segment, a right underlying segment, and a right lateral segment, and said generating step includes:
(i) modifying said left and right cups to comprise said perforated sheet;
(ii) modifying said left and right lateral segments, left and right lower segments, and left and right medial segments to comprise a support structure having a denser or less elastic property than that of the left and right cups.

16. The method of claim 15, further comprising:
(iii) dividing said front portion through said center segment to produce half portions having opposing edge portions; and
(iv) adding corresponding connector segments to said opposing edge portions.

17. The method of claim 1, wherein said garment is elastic.

18. The method of claim 1, further comprising:
(d) producing said support garment from said flattened virtual 3D model and a light polymerizable resin on an additive manufacturing apparatus;
(e) optionally cleaning said support garment or a part thereof; and then
(f) optionally further curing said object.

19. The method of claim 18, wherein said producing step is carried out by bottom up stereolithography, top down stereolithography, or multi jet printing.

20. The method of claim 18, wherein said further curing step is carried out with said object in a flattened state.

21. The method of claim 18, wherein said further curing step is carried out with said object on a contoured form.

22. The method of claim 18, wherein said light polymerizable resin comprises a resin for a polymerized product comprised polyurethane, polyurea, or copolymer thereof, or for product comprised of silicone

23-24. (canceled)

25. An additively manufactured brassiere, comprising:
left and right cups. each cup comprising a perforated sheet
a center segment connecting said left and right cups to one another;
a left lateral segment, a left underlying segment, and a left medial segment all connected to said left cup;
a right medial segment, a right underlying segment, and a right lateral segment all connected to said right cup;
said left and right lateral segments, left and right lower segments, and left and right medial segments all comprising support structures,
said cups and said support structures all produced concurrently with one another and connected to one another from a same light polymerizable resin by additive manufacturing.

26-32. (canceled)

33. A method of making a support garment and complementary prosthesis, comprising:
(a) receiving, into a computing system, a 3D image of a human body portion;
(b) generating in said computing system a virtual 3D model of a custom prosthesis that conforms to said 3D image of a human body portion;
(c) generating in said computing system an initial virtual 3D model of a support garment in a configuration corresponding to said 3D image and said custom prosthesis, said garment having an outer surface, an inner, body-facing surface, and a thickness dimension therebetween, and
(d) modifying at least a first zone of said initial virtual 3D model to comprise a perforated sheet.

34-74. (canceled)
